(19) United States
(12) Patent Application Publication
(10) Pub. No.: US 2014/0091544 A1
(43) Pub. Date: Apr. 3, 2014

(54) RIDING DEVICE WITH GRIND PEGS

(71) Applicant: NEXTSPORT, INC., Emeryville, CA (US)

(72) Inventor: Rasyad Chung, Berkeley, CA (US)

(73) Assignee: Nextsport, Inc., Emeryville, CA (US)

(21) Appl. No.: 13/632,651

(22) Filed: Oct. 1, 2012

(51) Int. Cl. B62M 1/00

(52) U.S. Cl. 280/87.041

(57) ABSTRACT

An expandable top collar system (10) for a golf bag (12) is provided for providing one or more expandable apertures (36) facilitating a smaller lateral aspect collapsed mode (14) and a larger aspect expanded mode (16). The system (10) includes expansion means (37) and securing means (49) associated with each expandable aperture (36) so as to define the degree of aspect expansion.

### TECHNICAL FIELD

The present invention relates generally to riding devices and particularly to non-powered recreational scooters.

### BACKGROUND ART

Non-powered riding devices of various sorts are very popular items used in acrobatic play activities and “extreme sports”, particularly among adolescents and young adults. Examples of these items are skateboards, snowboards, trick cycles and recreational scooters. While those devices which are suitable for use on dry and solid surfaces (as opposed to snow ice or water) are also suitable for personal transportation, they are also frequently utilized for trick and performance activities, as well. Special facilities, such as skateboard parks, are provided for these activities, but they are also often performed in unofficial arenas.

Wheeled performance riding devices, especially skateboards and scooters, are preferred for a variety of tricks. One of the most popular forms of tricks involves what is known as a “grind” or “grinding”. A rider is said to “grind” when the device slides along an edge, rail or other surface on some part of the device other than the wheels. For example, a skateboarder will grind along a pipe, by placing the center bottom of the board deck (usually the wheel support brackets) on the pipe and sliding along the pipe for a distance (in this fashion “grinding” the surface of the bracket on the pipe).

This sort of trick is much more difficult with two-wheeled scooters which, like inline skates, have the wheels centrally located and aligned, so there is no central balancing point upon which to grind. Accordingly, there is a need for effective grind peg structures to allow scooter riders to perform this type of trick maneuver.

### DISCLOSURE OF INVENTION

Accordingly, it is an object of the present invention to provide a two-wheeled scooter with effective grind pegs.

Another object of the invention is to provide grind pegs for a scooter which are displaced from the steered wheel.

A further object of the present invention is to provide grind pegs which enhance the structural integrity of the scooter and the alignment of the rear wheel structures.

Yet another object of the invention is to provide a rear grind peg subassembly which further functions to align and support the rear wheel in a firm and stable orientation.

Still another object of the invention is to provide a scooter with replaceable grind surface elements, so that worn out parts can be replaced and alternate types of surfaces can be utilized.

Another object of the invention is to provide adjustable weighting which can modify the “spinning feel” of the scooter in certain tricks.

Briefly, one preferred embodiment of the present invention is a two-wheeled, non-powered recreational scooter, being generally laterally symmetrical about a vertical wheel plane and having integral grind peg members for performing grinding, sliding and balancing tricks while riding. The improved scooter includes a generally conventional front structure including a handle, riser, a customized and reinforced head tube, front fork and front wheel, attached to an inventive deck frame by a reinforced neck. The preferred deck frame is hollow and internally buttressed and is open to the front and rear. The deck frame includes a rear slot to receive the front half of the rear wheel for free rotation therein. A transverse front grind peg is bonded to the open front of the deck frame such that the grind peg extends forward and below the deck frame. A left rear grind peg and a right rear grind peg are bonded to the open rear of the deck frame, to the sides of the rear slot such that each rear grind peg extends rearward and below the deck frame. Each grind peg has a grinding surface on the bottom for grinding, sliding and balancing on raised terrain elements. The rear grind pegs also mutually support a rear axle and support and align the rear wheel. Alternate embodiments include removable and replaceable grind peg covers and weight washers to modify weight distribution.

An advantage of the present invention is that it provides a recreational scooter which is capable of being used for grinding tricks which were previously only available to skateboards.

Another advantage of the invention is that it provides multiple grinding surfaces, each transversely displaced from the wheel plane to facilitate grinding on either the left or right side of the scooter.

An additional advantage of the invention is that the grind pegs improve the lateral stability and structural integrity of the deck.

Still another advantage is that the rear grind peg subassembly greatly enhances the stability and alignment to the rear wheel.

Yet another advantage provided by the alternate embodiment is that the user may install grind peg covers having alternate grinding surfaces for special purposes and may also replace worn peg ends.

A still further advantage of the invention is that weight washers or similar weight elements may be provided to adjust the balance of the scooter and to enhance certain tricks performed by the user.

These and other objects and advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF THE DRAWINGS

The purposes and advantages of the present invention will be apparent from the following detailed description in conjunction with the appended drawings in which:

FIG. 1 is a front right perspective view of a two-wheeled non-powered recreational scooter equipped with integral grind pegs according to the presently preferred embodiment of the invention;

FIG. 2 is a right side elevational view of the preferred embodiment of the present invention;

FIG. 3A is rear right perspective view of the deck subassembly, the grind peg subassembly and the rear wheel subassembly;

FIG. 3B is an exploded view of the assemblies of FIG. 3A;

FIG. 4 is a partially cut-away top view of the rear portion of the deck frame, the rear wheel subassembly, and the rear grind peg subassembly; and

FIG. 5 is an exploded cut-away perspective view of the rear portion of the scooter showing an alternate embodiment provided with removable and replaceable grind peg covers and weight washers.

### BEST MODE FOR CARRYING OUT THE INVENTION

The present invention is an improved two-wheeled scooter structure which is adapted to improved performance in trick maneuvers and particularly in performing grinds. The presently preferred embodiment of a grind peg equipped scooter is shown in the various figures of the drawing and referred to by the general reference character 10 in the description.

The following description refers to all of the figures of the drawing, with occasional specific reference to one or more of the figures to address particular features primarily or only shown in that figure.

A scooter according to the present invention will be generally laterally symmetrical about a vertical wheel plane 11. The preferred scooter 10 may be considered to be an aggregation of a number of subassemblies which are connected to and operate together. These include a handle subassembly 12, a front wheel subassembly 14, a deck subassembly 16, a rear wheel subassembly 18 and, in the present invention, a grind peg subassembly 20. In the present embodiment, the grind peg subassembly 20 includes multiple components, these being a front grind peg 22 and a rear grind peg subassembly 24, which are spatially separated from each other but which perform partially similar functions.

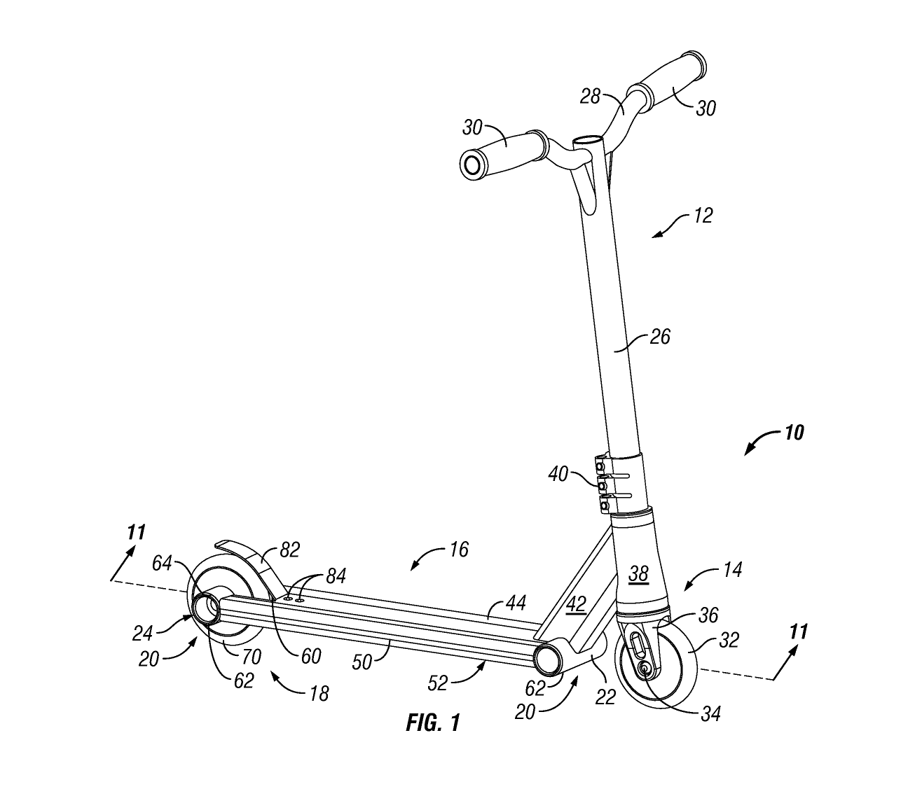

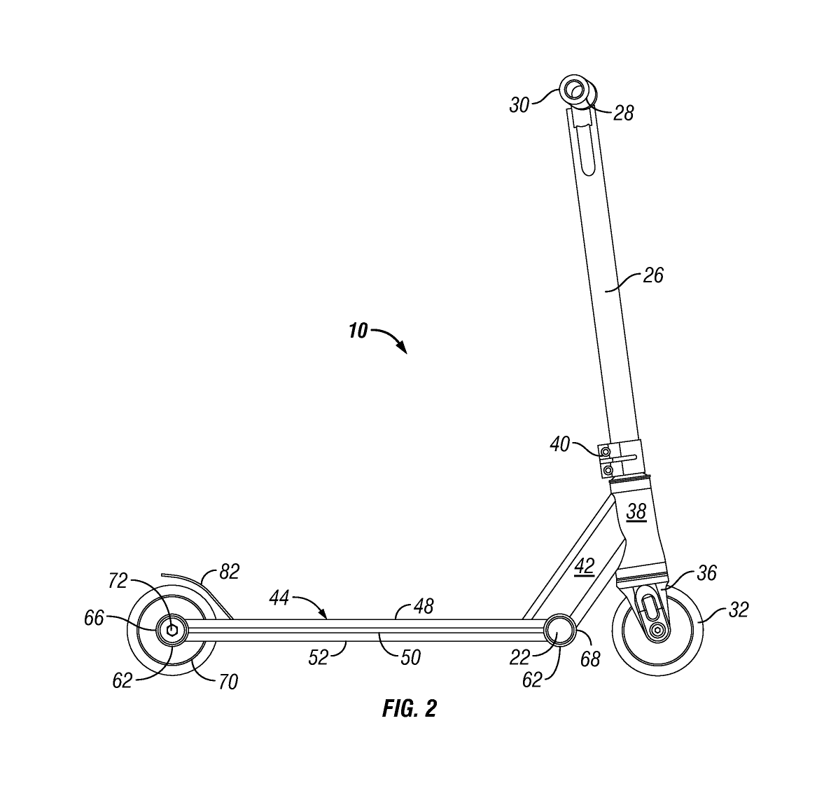

As particularly illustrated in FIGS. 1 and 2, the handle subassembly 12 includes a riser (tube) 26, a T-bar 28, and a pair of handle grips 30 situated on the T-bar 28. The handle subassembly 12 of the present invention 10 is generally conventional and is utilized by the rider to control and steer the scooter 10.

The front wheel subassembly 14, illustrated particularly in FIGS. 1 and 2, includes a front wheel 32 mounted on a front axle 34 which interfaces with a fork 36. The fork 36 extends upward through a head tube 38 to affirmatively engage the riser 26. A clamp 40 engages the outside of the riser 26 and helps to secure the fork 36 and riser 26 together to constitute a secure support and steering unit. All of the components of the handle subassembly 12 and front wheel subassembly 14, except for the head tube 38, are adapted to rotationally pivot with respect to the head tube 38 and the remainder of the scooter 10. Again, the illustrated front wheel subassembly 14 is generally conventional, although the conical head tube 38 and the unique clamp 40 are previously unknown in the scooter field.

A neck 42 extends from the head tube 38 rearward and downward to engage and secure the front wheel subassembly 14 to the deck subassembly 16.

The inventive deck frame 44 of the preferred embodiment of the present invention is a hollow extruded member with internal buttresses 46 formed for both strength and light weight. The deck frame 44 has a textured upper surface 48 for traction with solid sides 50 and a bottom surface 52. A front end 54 and a rear end 56 are open and shaped to receive the components of the grind peg subassembly 20. A front aperture 58 on the upper surface 48 receives the neck 42 while a central rear slot 60 extending through the entire deck frame 44 receives part of the rear wheel subassembly 18.

The front grind peg 22 is attached (preferably welded) to the front end 54 to seal the front of the deck frame 44 and also to provide a pair of grinding surfaces 62 extending below the deck frame 44 and transversely to the sides of the front wheel 32 (and laterally displaced from the vertical wheel plane 11). In the preferred embodiment 10 illustrated in the drawings the front grind peg 22 is an integral hollow cylindrical tube which is transversely coextensive with the deck frame 44, although alternate embodiments could have it extend further.

The open rear end 56 of the deck frame is split by the rear slot 60. The portions to the sides of the rear slot 60 are sealed by welding or otherwise securing a left rear peg 64 and a right rear peg 66, which together form the rear grind peg subassembly 24. The left rear peg 64 and right rear peg 66 are similar in shape and form to the front grind peg 22. Although many tricks are performed using only the front grind peg 22 for grinding, the rear pegs 64 and 66 also provide grinding surfaces 62. All lateral ends 68 of the grind peg 22, left rear peg 64 and right rear peg 66 are beveled or otherwise provided with buffered surfaces for safety purposes should the user contact those end surfaces 68.

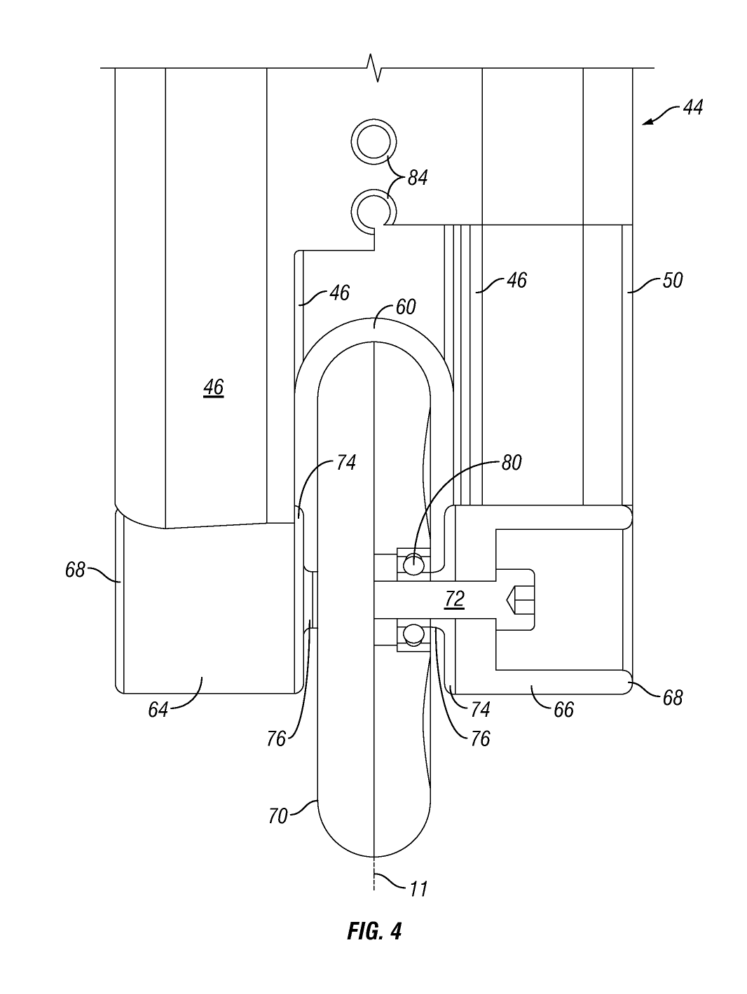

The rear wheel subassembly 18 includes a rear wheel 70 which rotates on a rear axle (bolt) 72 and partially extends forward into the rear slot 56. This is particularly illustrated in the partially cut-away top view of FIG. 4.

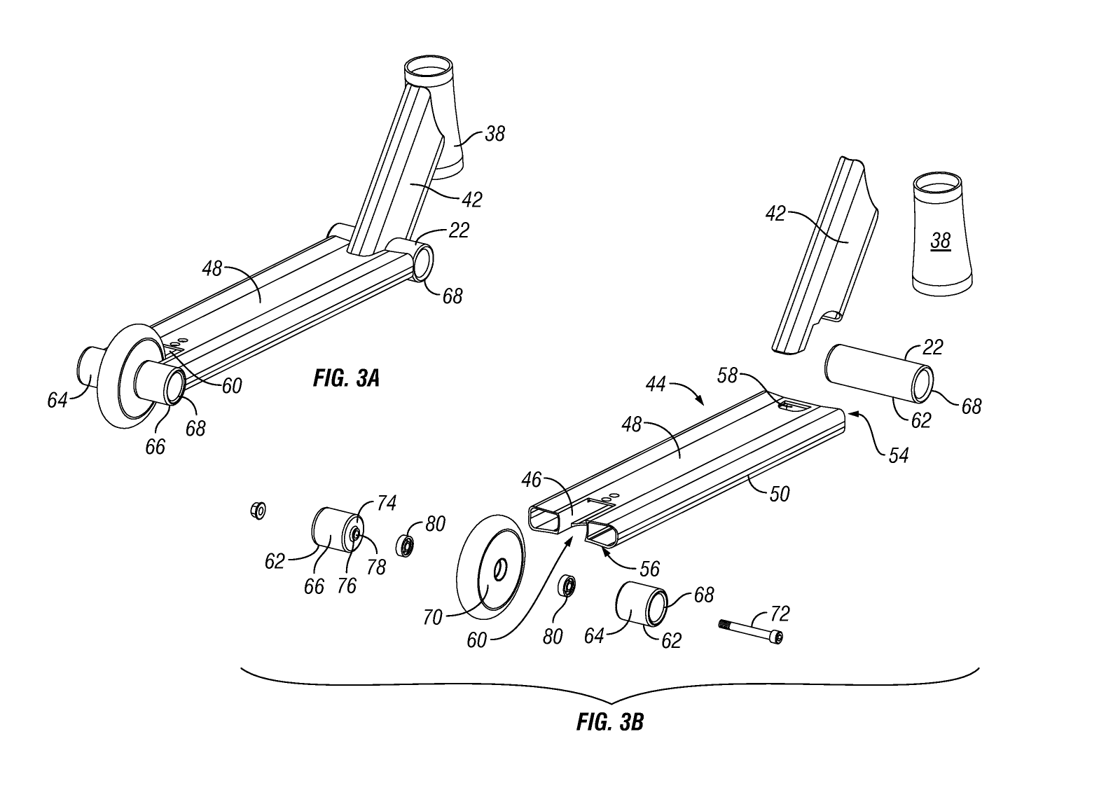

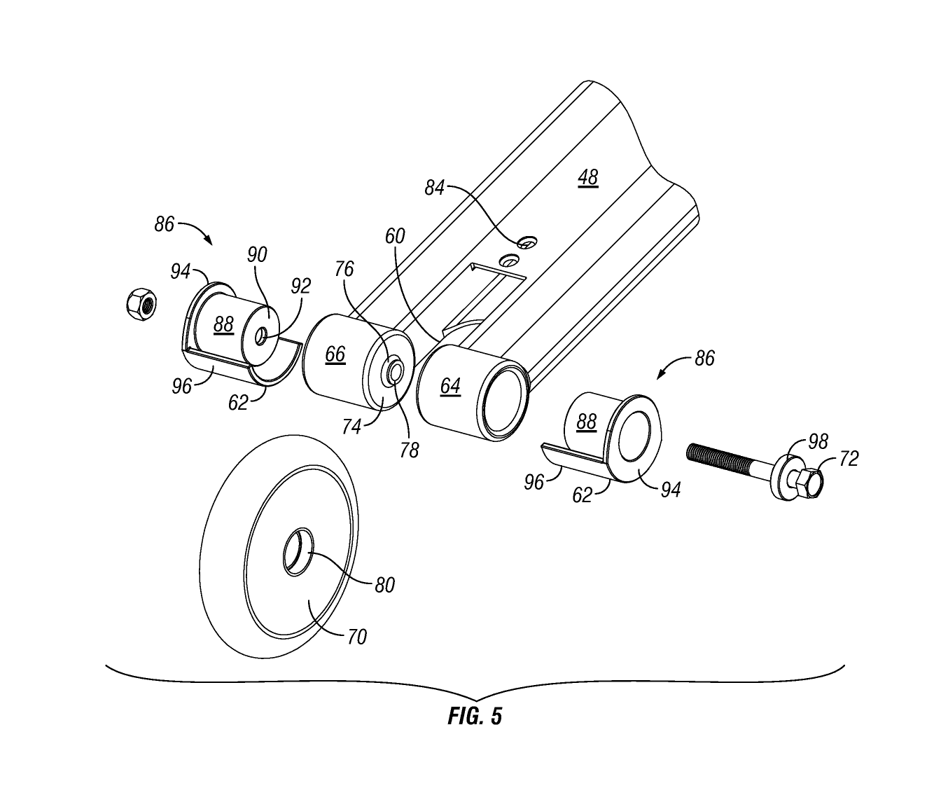

The rear grind peg subassembly 24 forms an integral part of the rear wheel subassembly 18, as the left rear peg 64 and the right rear peg 66 provide the lateral supports for the rear axle 72. As shown in FIGS. 4 and 5, each rear grind peg 64 and 66 is provided with an inside disk 74 which has a nub 76 having a central aperture 78 for receiving the rear axle bolt 72. The opposing nubs 76 precisely align the rear axle 72, and particularly the wheel bearings 80 (see especially in the exploded view of FIG. 3B and the cut-away portion of FIG. 4), as the inner race of each wheel bearing 80 abuts against the respective nub 76 and is secured in position and alignment thereby. For this reason the welding and alignment of the rear pegs 64 and 66 onto the deck frame 44 is critical to proper functioning of the scooter 10.

The inside disk elements 74 in an alternate embodiment are intended to be removable and replaceable in the event of failure, loss of alignment, or excessive wear, while the inside disk 74 may also be an integral part of each of the rear pegs 64 and 66.

As is particularly shown in FIGS. 1 and 2, a friction brake 82 is provided above the rear wheel 70. The friction brake 82 is a resilient shaped-metal strip secured to the deck frame 44 at a pair of bolt holes 84 situated just forward of the rear slot 60. When the user wishes to brake the scooter 10, pressure is applied to the friction brake 82 to force it against the rear wheel 70 and frictionally slow the rotation.

FIG. 5 shows and exploded perspective view of a portion of an embodiment of the invention having additional components intended to enhance the longevity, the riding experience, and the trick performance of the scooter. A pair of grind covers 86 are shown in FIG. 5 which are adapted to mate with the rear grind pegs 64 and 66 to provide a replaceable grinding surface 62. Each grind cover 86, in the embodiment shown, is integrally formed to have a hollow inner cylinder 88 having an inner cap 90 with a central bolt hole 92, an end cap 94, and a grinding arc plate 96 extending back from the end plate 94 and being radially spaced from the inner cylinder 88. The grinding arc plate 96 provides an exterior grinding surface 62 outside of the surface found on the grind pegs 64 and 66.

The grind covers 86 are adapted to mate with the grind pegs 64 and 66 (and in a slightly longer version with the front grind peg 22) with the inner cylinder 88 nesting relatively tightly in the interior of the associated grind peg, the end cap 94 abutting against and extending from the associated lateral end 68, and the grinding arc plate 96 fitting relatively tightly against the lower extent of the outer surface of the grind peg. In a rear installation, the rear axle bolt 72 passes through both of the grind covers 86 and holds them (and the other elements of the rear wheel subassembly 18) in place by tightening together. In a front assembly an additional bolt will be used to secure the grind covers 86 in place on the front peg 22. The grinding arc plate 96 will abut on one edge against the deck frame 44 to further inhibit rotation.

The removable and replaceable grind covers allow the user to utilize a longer-lasting grinding surface 62 (such as steel) than on the lighter material of the aluminum grind pegs which may be used in some embodiments. It also allows a lower grinding surface 62 by extending radially below the associated peg. The replaceability permits relatively easy replacement and repair, thus extending the life of the scooter 10.

Alternate methods of mounting replaceable auxiliary grind surfaces are also envisioned, such as bolting an arced metal sheath about a portion of the grind peg or using an expansion structure against the interior surface of the grind peg to secure a grind cover in place.

Another optional innovation is the option to adjust the weight balance of the scooter 10. One weight balance adjustment is shown in FIG. 5 as a weight washer 98 placed on the rear axle bolt 72 to one side of the wheel plane 11. The placement of one or more weight washers 98 can allow the user to balance or unbalance the scooter 10 in various ways, such as overweighting one side to enhance spinning tricks or adding additional weight to the front or rear of the scooter to improve the “feel” for a particular rider. The number and positioning, and selection of different weight types for the weight washers 98 is a matter of choice for the user and these may be placed within the grind pegs as desired. Alternatively, other methods of adjusting the balance may be used, such as weighted tape or magnetic weights place inside the grind covers 86.

The preferred grind peg elements of the present embodiment are round cylinders. However it is envisioned that other shapes, particularly square tubes and octagonal tubes, would be effective, as each would present a more extensive grinding surface 62 than the tangential effect provided by the circular cross-section, albeit with the detriment of losing the capability of operating on different vertical angles. The hollow structures are desirable in order to minimize weight.

Some of the structural components, those rigid with respect to each other, are preferably joined by welding in order to maximize structural strength. Various portions of the structure, particularly the front end 54 and back end 56 of the deck frame 44, and the neck 42 (both front and back edges) are shaped to mate easily with the components to be welded thereto to facilitate long and strong welds.

With the exceptions of the wheels and the handle grips, the components of the preferred scooter 10 are constructed of strong and light structural metals, usually aluminum. It is envisioned that the grinding surfaces 62 will be clad with or constructed of materials resistant to wear during use, such as stainless steel.

The dimensions of the components will vary depending on particular uses, but will generally be in accordance with conventional scooter construction. The grind pegs 22, 64 and 66 are constructed to extend below the bottom surface 52 of the deck frame 44, such that the grinding surfaces 62 are spatially separated from the remainder of the scooter components.

Many modifications to the above embodiment may be made without altering the nature of the invention. The dimensions and shapes of the components and the construction materials may be modified for particular circumstances or types of scooter desired.

While various embodiments have been described above, it should be understood that they have been presented by way of example only, and not as limitations.

### INDUSTRIAL APPLICABILITY

The improved scooter 10 with grind pegs of the present invention will ordinarily be built as original manufacture.

In most respects the scooter 10 of the present invention will function and operate like a conventional recreational scooter. The user will note improved stability resulting from the improved structure of the deck frame 44, the integral buttressing and transverse structure provided by the grind peg elements 22, 64 and 66 being welded to the frame, and the superior mounting of the rear wheel 70 (provided by the unique structure of the rear grind pegs 64 and 66) to keep the wheel firmly locked in a perpendicular orientation with respect to the deck frame 44. The user will also have improved “feel” and security, particularly in the feet.

However the most distinctive improved value of the present invention occurs when the user wishes to engage in grinding tricks. The user has the option of grinding (sliding or balancing) on either side of the wheel plane 11 since both front and rear grind pegs extend transversely beyond the wheel plane 11. While many tricks will involve grinding only on the front grind peg 22, it is also feasible to grind simultaneously on both front and rear grinding surfaces 62 (on the same side of the wheel plane 11, in almost all conceivable circumstances). It is even envisioned that adventurous riders will engage in grinding only on a rear peg 64 or 66. The provision of grind pegs and grinding surfaces at locations displaced from the front wheel greatly enhances the ability of the user to grind and balance on the scooter and broadens the repertoire of tricks which may be performed, as well as enhancing the safety of the device.

For the above, and other, reasons, it is expected that the improved scooter 10 integral grind pegs of the present invention will have widespread industrial applicability. Therefore, it is expected that the commercial utility of the present invention will be extensive and long lasting.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

What is claimed is:

1. An improved scooter including a handle, a front wheel subassembly and a rear wheel subassembly, and further comprising:
a deck frame secured to a transverse front grind peg extending forward of and below said deck frame, said grind peg having a grinding surface situated on the bottom thereof.

2. The improved scooter of claim 1, and further including:
a rear grind peg subassembly secured to the rear of said deck frame so to extend rearward and below said deck frame, said rear grid peg subassembly including left and right grind pegs, each including a grinding surface on the bottom thereof.

3. The improved scooter of claim 2, wherein:
said deck frame is hollow.

4. The improved scooter of claim 2, wherein:
said front grind peg is secured to the front of said deck frame by welding and said left and right rear grind pegs are secured to the rear of said deck frame by welding.

5. The improved scooter of claim 2, wherein:
said left and rear grind pegs receive a rear axle upon which, at a position between said left and right rear grind pegs, a rear wheel rotates.

6. The improved scooter of claim 2, and further including:
replaceable grind covers secured to said front grind peg and said left and right rear grind pegs to provide grinding surfaces.

7. The improved scooter of claim 1, wherein:
said scooter is generally symmetrical about a vertical wheel plane.

8. The improved scooter of claim 7, wherein:
replaceable grind covers are secured to said front grind peg and said left and right rear grind pegs to provide grinding surfaces.

9. The improved scooter of claim 8, wherein:
said replaceable grind covers are arrayed in pairs with one on each side of said vertical wheel plane.

10. The improved scooter of claim 3, and further including:
balance and weight adjusters secured by the user to said grind pegs.

11. The improved scooter of claim 10, wherein:
said balance and weight adjusters are weight washers.

12. A two-wheeled, non-powered recreational scooter, comprising:
a handle, a front wheel, a deck frame and a rear wheel, all generally laterally symmetrical about a vertical wheel plane, and further including
a grind peg subassembly extending below said deck frame intermediate said front wheel and said rear wheel, said grind peg subassembly providing grind surfaces laterally displaced from said wheel plane.

13. The two-wheeled, non-powered recreational scooter of claim 12, wherein:
said grind peg assembly includes a front grind peg and a rear grind peg subassembly, with said rear grind peg subassembly including a left rear grind peg and a right rear grind peg.

14. The two-wheeled, non-powered recreational scooter of claim 13, wherein:
said front grind peg is a transversely mounted hollow cylinder.

15. The two-wheeled, non-powered recreational scooter of claim 13, wherein:
said left rear grind peg and said right rear grind peg are laterally separated and mutually align and support a rear axle upon which a rear wheel is mounted.

16. The two-wheeled, non-powered recreational scooter of claim 11, and further including:
a plurality of removable and replaceable grind covers mounted on said grind peg subassembly at positions to either side of said wheel plane.

17. The two-wheeled, non-powered recreational scooter of claim 12, wherein:
said deck frame is hollow and said grind peg subassembly includes grind peg elements secured to the front and the rear of said deck frame.

18. The two-wheeled, non-powered recreational scooter of claim 12, and further including:
balance and weight adjusters secured to said grind peg subassembly.
